(19) United States
(12) Patent Application Publication
(10) Pub. No.: US 2024/0429425 A1
(43) Pub. Date: Dec. 26, 2024

(54) METHOD FOR MANUFACTURING LAMINATED BATTERY AND APPARATUS FOR MANUFACTURING LAMINATED BATTERY

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 18/431,047

(22) Filed: Feb. 2, 2024

(30) Foreign Application Priority Data
Jun. 21, 2023 (JP) 2023-102054

(51) Int. Cl. H01M 10/04; B21D 5/00; H01M 50/105; H01M 50/119; H01M 50/121; H01M 50/124

(52) U.S. Cl. CPC H01M 10/0404; B21D 5/00; H01M 50/105; H01M 50/119; H01M 50/121; H01M 50/124

(57) ABSTRACT

A laminated battery includes an electrode body and a laminate film, wherein the laminate film has a structure in which at least a metal layer and a protective resin layer are laminated, and the laminate film has a fused portion in which end portions are overlapped and an inner surface is fused, wherein the laminated film has a bending step of bringing a bending member into contact with the fused portion so as to form one or more bent portions by bending in an angular or arcuate shape so as to have an angle of 90° or less, and the bending member is made of a conductive material, and the bending step is a step of performing the folding while confirming the conduction between the bending member and the metal layer of the laminate film.

### CROSS-REFERENCE TO RELATED APPLICATION

This application claims priority to Japanese Patent Application No. 2023-102054 filed on Jun. 21, 2023, incorporated herein by reference in its entirety.

### BACKGROUND

### 1. Technical Field

The present disclosure relates to a method for manufacturing a laminated battery and an apparatus for manufacturing a laminated battery.

### 2. Description of Related Art

In a laminated battery in which an electrode body is covered with a laminate film, part of the laminate film is fused to form a fused portion in order to encapsulate the electrode body. In order to improve the structural efficiency of a battery, the fused portion is bent.

For example, Japanese Unexamined Patent Application Publication No. 2019-200973 (JP 2019-200973 A) discloses a method for manufacturing a secondary battery including a bent portion at least at one end in a laminated exterior body. The method includes a step of bringing a holding plate into contact with a bending base point at the end of the exterior body, and a step of forming the bent portion after the contact step by sliding the holding plate and a pressing plate positioned to face the holding plate to sandwich the end, bending the end about the base point, and holding the end between the holding plate and the pressing plate. The surface of the pressing plate that slides against the end includes an inclined surface that bends the end and a holding surface that holds the end. In a cross section orthogonal to a width direction of the pressing plate, the inclined surface is inclined so that the sectional area of the pressing plate decreases in a sliding direction. The inclined surface is inclined in the width direction.

### SUMMARY

When the fused portion of the laminate film is bent at an angle of 90° or less to form a bent portion, cracking may occur in a protective resin layer of the laminate film. The cracking may occur in the protective resin layer on a mountain folding side at the bent portion, but is particularly remarkable in the protective resin layer on a valley folding side at the bent portion. Therefore, there is a demand for a method and an apparatus for manufacturing a laminated battery that can detect the occurrence of cracking in the protective resin layer on the valley folding side and the mountain folding side at the bent portion, and can accordingly remove a laminated battery having a crack in the protective resin layer (that is, a laminated battery having a defect) before shipment.

The present disclosure has been made in view of the above circumstances, and an object of the present disclosure is to provide a method for manufacturing a laminated battery and an apparatus for manufacturing a laminated battery that can detect whether cracking has occurred in a protective resin layer at a bent portion of a fused portion.

<1>

A method for manufacturing a laminated battery including an electrode body and a laminate film that covers the electrode body and encapsulates the electrode body inside, the laminate film including a structure in which at least a metal layer and a protective resin layer on an outer side of the metal layer are laminated, the laminate film including a fused portion in which ends overlap each other and inner surfaces are fused, the method including
a bending step of forming one or more bent portions by bringing a bending member into contact with the fused portion and bending the fused portion in an angular or arcuate shape at an angle of 90° or less, in which
the bending member is made of a conductive material, and
the bending step is a step of performing bending while checking conduction between the bending member and the metal layer of the laminate film.
   <2>

The method according to <1>, in which the bending member is a fulcrum member to be brought into contact with a valley folding side of the bent portion of the laminate film as a fulcrum.

<3>

The method according to <1> or <2>, in which the bending step is a step of forming the bent portion by placing a bending roll as the bending member and bringing the bending roll into contact with the fused portion of the laminate film while moving the laminated battery in a direction conforming to rotation of the bending roll.

<4>

The method according to <3>, in which the bending step is a step of forming the bent portion by placing a plurality of the bending rolls in a moving direction of the laminated battery and bringing the bending rolls sequentially into contact with the fused portion of the laminate film while moving the laminated battery, and performing the bending while checking conduction between at least the bending roll finally in contact with the bent portion and the metal layer of the laminate film.

<5>

An apparatus for manufacturing a laminated battery including an electrode body and a laminate film that covers the electrode body and encapsulates the electrode body inside, the laminate film including a structure in which at least a metal layer and a protective resin layer on an outer side of the metal layer are laminated, the laminate film including a fused portion in which ends overlap each other and inner surfaces are fused, the apparatus including:
a bending member made of a conductive material and configured to form a bent portion by coming into contact with the fused portion and bending the fused portion in an angular or arcuate shape at an angle of 90° or less; and
a conduction checker connected to the bending member and the metal layer of the laminate film and configured to check conduction between the bending member and the metal layer.

According to the present disclosure, it is possible to provide the method for manufacturing the laminated battery and the apparatus for manufacturing the laminated battery that can detect whether the cracking has occurred in the protective resin layer at the bent portion of the fused portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a laminated battery manufactured by a method and an apparatus for manufacturing a laminated battery according to the present embodiment;

FIG. 2 is a schematic cross-sectional view illustrating a bending step of forming a bent portion and an apparatus for manufacturing a laminated battery that forms the bent portion in the method for manufacturing a laminated battery according to the present embodiment;

FIG. 3 is a schematic cross-sectional view illustrating a state in which cracking occurs in the protective resin layer in FIG. 2; and

FIG. 4 is a schematic cross-sectional view illustrating an exemplary solid-state cell.

### DETAILED DESCRIPTION OF EMBODIMENTS

### Method and Apparatus for Manufacturing Laminated Battery

A method of manufacturing a laminated battery according to an embodiment of the present disclosure includes an electrode body and a laminate film that covers the electrode body and encloses the electrode body therein, wherein the laminate film has a structure in which at least a metal layer and a protective resin layer are laminated on the outside of the metal layer, and the laminate film has a fused portion in which end portions are superposed and the inner surface is fused.

The method for manufacturing a laminated battery includes a bending step of bringing a bending member into contact with a fused portion and bending the bending member in an angular shape or an arcuate shape so as to have an angle of 90° or less to form one or more bent portions. The bending member is made of a conductive material. Then, in the bending step, the bending is performed while confirming the conduction between the bending member and the metal layer of the laminate film.

An apparatus for manufacturing a laminated battery according to an embodiment of the present disclosure includes an electrode body and a laminate film that covers the electrode body and encloses the electrode body therein, wherein the laminate film has a structure in which at least a metal layer and a protective resin layer are laminated on the outside of the metal layer, and the laminate film has a fused portion in which end portions are overlapped and the inner surface is fused.

An apparatus for manufacturing a laminated battery includes a bending member made of a conductive material, which is bent in an angular shape or an arcuate shape so as to form a bent portion so as to have an angle of 90° or less in contact with a fused portion, and a conduction checker, which is connected to a metal layer of the bending member and the laminate film and confirms conduction between the bending member and the metal layer.

Hereinafter, an embodiment of a method and an apparatus for manufacturing a laminated battery according to the present disclosure will be described with reference to the drawings.

Each drawing shown below is schematically shown, and the size and shape of each part are appropriately exaggerated for easy understanding.

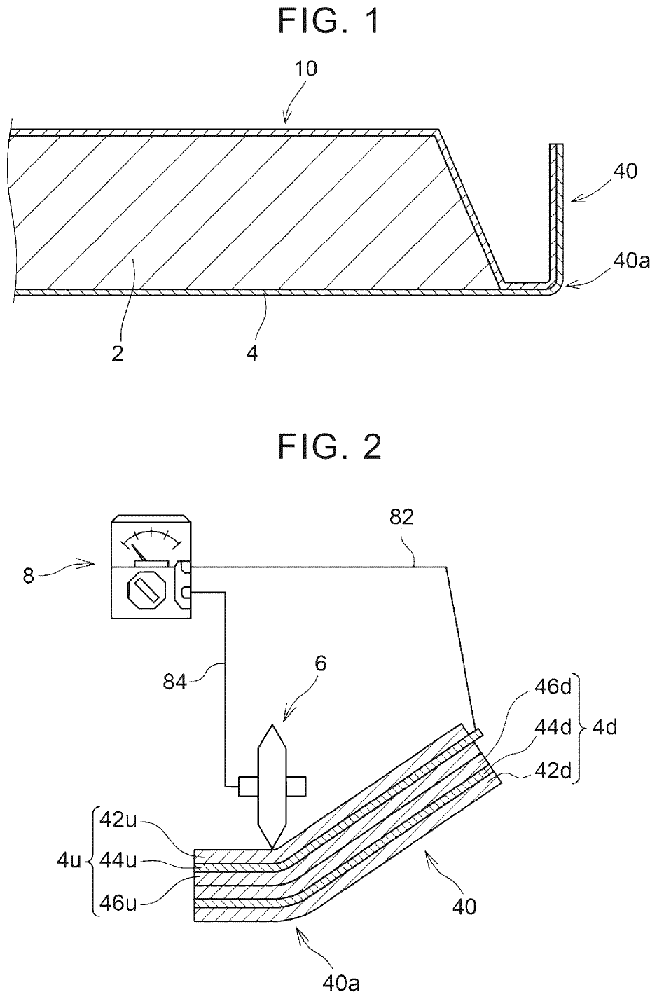

FIG. 1 is a schematic cross-sectional view illustrating a laminated battery manufactured by a method and an apparatus for manufacturing a laminated battery according to the present embodiment.

The laminated battery 10 shown in FIG. 1 includes an electrode body 2 and a laminate film 4 that covers and encloses the electrode body 2. The laminate film 4 forms a fused portion 40 in which the end portions are overlapped with each other and the inner surface is fused. The fused portion 40 has a bent portion 40a bent in an angular shape or an arcuate shape so as to have an angle of 90° or less.

Here, a bending step of forming the bent portion 40a and a device for manufacturing a laminated battery for forming the bent portion 40a will be described with reference to FIG. 2.

In the fused portion 40 shown in FIG. 2, the end portions of the laminate film 4 are superposed on each other and the inner surface thereof is fused, that is, one end 4u of the laminate film 4 and the other end 4d are superposed on each other. Each of the one end 4u and the other end 4d of the laminate film 4 has a three-layer structure in which a metal layer 44u, 44d, a protective resin layer 42u, 42d on the outer side of the metal layer 44u, 44d, and a fusion resin layer 46u, 46d on the inner side of the metal layer 44u, 44d are laminated.

In FIG. 2, the bending roll 6 as a bending member is in contact with the protective resin layer 42u on one end 4u of the laminate film 4 in the fused portion 40, as a fulcrum the point where the bending roll 6 is in contact, the bent portion 40a is formed by bending so that the 90° or less of the angle. In other words, the bending roll 6 is a fulcrum member that is contacted as a fulcrum to the valley folding side in the bent portion 40a. The bending roll 6 is rotated in a direction in which the contact point with the laminate film 4 is toward the front side in FIG. 2. The laminated battery having the fused portion 40 moves in a direction corresponding to the rotation of the bending roll 6, that is, in a direction toward the front side in FIG. 2, and the bent portion 40a is formed by contacting the bending roll 6 with the moving fused portion 40. Incidentally, although not shown, the mountain folding side in the bent portion 40a (the lower side of the fused portion 40 in FIG. 2), the opposing member as a bending member (e.g. opposed roll) may be contacted.

The laminated battery manufacturing apparatus shown in FIG. 2 includes an ammeter 8 as a conduction checker. The ammeter 8 is connected to the bending roll 6 as a bending member and the metal layer 44u on one end 4u of the laminate film 4 by the conductive wires 82 and 84. Note that the metal layers 44u on the one end 4u of the laminate film 4 are connected to the conductive wires 82 so that a part thereof is exposed.

A method and an apparatus for manufacturing a laminated battery according to the related art will now be described.

When the fused portion of the laminate film is bent so as to have an angle of 90° or less to form a bent portion, cracks may occur in the protective resin layer of the laminate film. This is considered to be a crack caused by concentration of stress at a bent portion of the protective resin layer due to bending. Incidentally, the occurrence of this crack may occur in the protective resin layer on the mountain folding side in the bent portion, in particular in the protective resin layer on the valley folding side in the bent portion is remarkable. This is considered to be because stress is more concentrated on the valley folding side, and cracks are more likely to occur starting from the contact position due to the bending member being pressed.

Further, when the crack occurs in the protective resin layer of the valley folding side in the bent portion, it becomes difficult to determine the presence or absence of cracks, and further, as the angle of bending in the bent portion becomes shallower (that is, as the angle becomes acute angle) crack determination becomes more difficult. However, in a laminate film which is a thin film, it is difficult to find cracks by non-destructive inspection such as X-ray inspection.

Therefore, there has been a demand for a method and an apparatus for manufacturing a laminated battery that can detect the occurrence of cracks in the protective resin layer on the valley folding side and the mountain folding side in the bent portion.

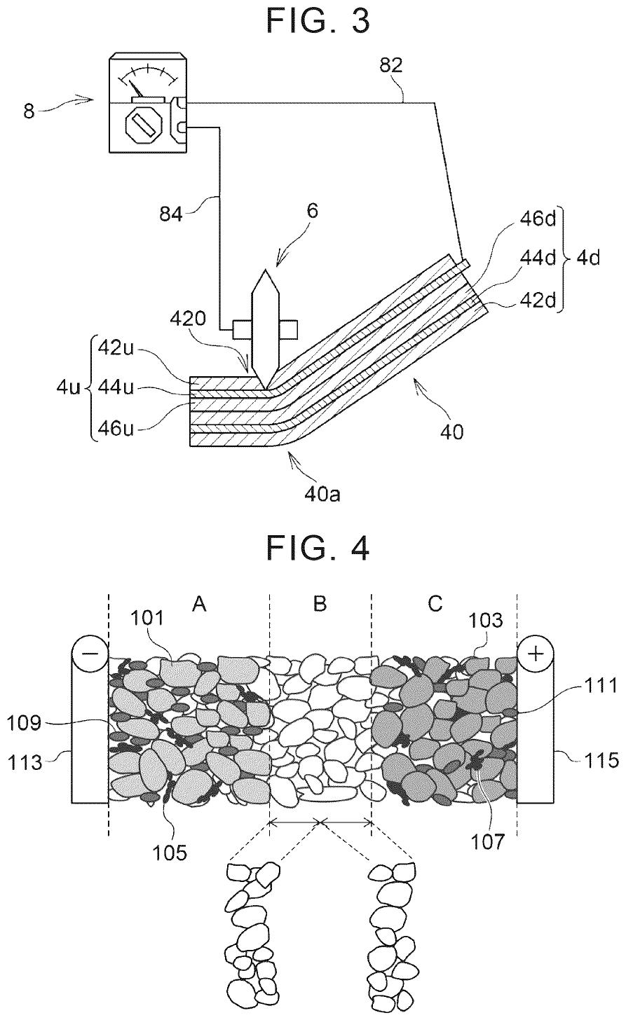

On the other hand, in the present embodiment, as shown in FIG. 2, an ammeter 8 is provided as a conduction checker that is connected to the bending roll 6 and the metal layer 44u, which are bending members, and confirms conduction between the bending roll 6 and the metal layer 44u. The ammeter 8 performs bending while confirming the conduction between the bending roll 6 and the metal layer 44u. In a state in which no crack is generated in the protective resin layer 42u on 4u side of the laminate film 4 (that is, a state shown in FIG. 2), the bending roll 6 and the metal layer 44u are not contacted with each other, and electric continuity is not confirmed. However, as shown in FIG. 3, when cracks 420 occur in the protective resin layer 42u on 4u of the laminate film 4 and the bending roll 6 and the metal layer 44u are contacted with each other, electric continuity is confirmed in the ammeter 8. Accordingly, in the present embodiment, since electrical continuity is confirmed when the protective resin layer is torn, it is possible to confirm the presence or absence of a tear in the protective resin layer in the laminate film of the laminated battery to be manufactured. As a result, a laminated battery (that is, a laminated battery having a defect) in which a crack has occurred in the protective resin layer can be removed before shipment.

Note that FIG. 2 shows a mode in which the bending roll 6 as a bending member connected to the ammeter 8 as a conduction checker is a fulcrum member which is brought into contact with the valley folding side in the bent portion 40a of the fused portion 40 as a fulcrum. However, the present disclosure is not limited thereto, and a bending member (for example, a bending roll) connected to the conduction checker may be brought into contact with the crest folding side of the bent portion of the fused portion. In this case, it is possible to detect the presence or absence of occurrence of cracks in the protective resin layer on the mountain folding side in the bent portion of the fused portion. In addition, a bending member (for example, a bending roll) connected to the conduction checker may be brought into contact with both the valley folding side and the mountain folding side in the bent portion of the fused portion. In this case, it is possible to detect the presence or absence of occurrence of cracks in the protective resin layer on the mountain folding side and the protective resin layer on the valley folding side in the bent portion of the fused portion.

In the embodiment of the present disclosure, a plurality of bending rolls may be arranged in the moving direction of the laminated battery, and the bent portion may be formed by sequentially bringing the plurality of bending rolls into contact with the fused portion of the laminate film while moving the laminated battery and performing the bending. In this case, it is preferable to carry out the bending while confirming the conduction between the bending roll and the metal layer of the laminate film, at least finally contacting the bent portion. Finally, by checking the conduction between the bending roll in contact with the bent portion and the metal layer of the laminate film, it is possible to detect the crack generated before the bending roll comes into contact with the bent portion.

The number of bent portions in the fused portion is one or more, and may have two or more bent portions. The angle of the bent portion of the fused portion may be 90° or less, may be an acute angle than 90°, also the angle of the bent portion may be 0° (that is, the bent portion of the shape fused portion is bent 180°). The bent portion has a shape bent in a corner shape or an arc shape. Angular means a shape having corners, and arcuate means a curved shape having no corners.

Although a bending roll is illustrated in FIG. 2 as a bending member, the present disclosure is not limited thereto. For example, as the bending member, a plate-shaped member serving as a fulcrum member may be brought into contact with the valley folding side of the bent portion, and a block-shaped pressing member may be brought into contact with the mountain folding side of the bent portion to be bent. At least a part of the bending member is made of a conductive material. Specifically, a portion in contact with the protective resin layer of the fused portion (that is, a portion in contact with the inner metal layer when a crack occurs in the protective resin layer), and a portion connected to the conduction checker, at least a portion is made of a conductive material so as to be electrically conductive. The bending member may be made entirely of a conductive material. Examples of the conductive material include metal.

Although an ammeter is shown in FIG. 2 as the conduction checker, the present disclosure is not limited thereto, and may be any means capable of checking electrical continuity such as a voltmeter and a resistance measuring instrument.

### Components of Battery

Next, an electrode body and a laminate film constituting a laminated battery manufactured by the method and the apparatus for manufacturing a laminated battery according to the present embodiment will be described.

### (1) Laminate Film

The laminate film has a structure in which at least a metal layer and a protective resin layer are laminated on the outside of the metal layer. Further, the film may be a three-layer film having a fused resin layer on the inner side of the metal layer.

Examples of the adhesive resin include olefinic resins such as polypropylene (PP) and polyethylene (PE). Examples of the material of the metal layer include aluminum, aluminum alloy, and stainless steel. Examples of the protective resin layer include polyethylene terephthalate (PET), and nylon. The thickness of the fusion resin layer is, for example, 40 μm or more and 100 μm or less. The thickness of the metal layer is, for example, 30 μm or more and 60 μm or less. The thickness of the protective resin layer is, for example, 20 μm or more and 60 μm or less. The thickness of the entire laminate film is, for example, 70 μm or more and 220 μm or less.

### (2) Electrode Body

The electrode body functions as a power generation element of the battery. The electrode body generally includes a positive electrode current collector, a positive electrode active material layer, an electrolyte layer, a negative electrode active material layer, and a negative electrode current collector in this order in the thickness direction.

The positive electrode active material layer contains at least a positive electrode active material. The positive electrode active material layer may further contain at least one of a conductive material, an electrolyte, and a binder. The shape of the positive electrode active material is, for example, particulate. Examples of the positive electrode active material include an oxide active material. Further, sulfur (S) may be used as the positive electrode active material.

The positive electrode active material preferably contains a lithium-composite oxide. The lithium-composite oxide may contain at least one selected from the group consisting of F, Cl, N, S, Br, and I. The lithium-composite oxide may have a crystal structure belonging to at least one space group selected from space groups R-3m, Immm, and a P63-mmc (also referred to as P63mc, P6/mmc). In addition, the lithium complex oxide may have a structure in which the main arrangement of the transition-metal, the oxygen, and the lithium is O2.

As the lithium-composite oxide having a crystal structure belonging to R-3m, examples includes compounds represented by LiₓMe_{y}O_{α}X_{β} (Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, X represents at least one selected from the group consisting of F, Cl, N, S, Br, and I, and 0.5≤x≤1.5, 0.5≤y≤1.0, 1≤α<2, and 0<β≤1 are satisfied).

As the lithium-composite oxide having a crystal structure belonging to Immm, examples include composite oxides represented by Liₓ₁M¹A¹₂ (1.5≤x1≤2.3 is satisfied, M¹ includes at least one selected from the group consisting of Ni, Co, Mn, Cu, and Fe, A¹ includes at least oxygen, and the proportion of oxygen in A¹ is 85 atomic % or more) (a specific example is Li₂NiO₂), composite oxides represented by Liₓ₁M^{1A}₁₋ₓ₂M^{1B}ₓ₂O_{2-y}A²_{y} (0≤x2≤0.5, 0≤y≤0.3, at least one of x2 and y is not 0, M^{1A} represents at least one selected from the group consisting of Ni, Co, Mn, Cu, and Fe, M^{1B} represents at least one selected from the group consisting of Al, Mg, Sc, Ti, Cr, V, Zn, Ga, Zr, Mo, Nb, Ta, and W, and A² represents at least one selected from the group consisting of F, Cl, Br, S, and P).

As the lithium-composite oxide having a crystal structure belonging to P63-mmc, examples include composite oxides represented by M1ₓM2_{y}O₂ (M1 represents an alkali metal (at least one of Na and K is preferred), M2 represents a transition metal (at least one selected from the group consisting of Mn, Ni, Co, and Fe is preferred), and x+y satisfies 0<x+y≤2).

As the lithium-composite oxide having an O2 type structure, examples include composite oxides represented by Liₓ[Li_{α}(MnₐCo_{b}M_{c})_{1-α}]O₂ (0.5<x<1.1, 0.1<α<0.33, 0.17<a<0.93, 0.03<b<0.50, 0.04<c<0.33, and M represents at least one selected from the group consisting of Ni, Mg, Ti, Fe, Sn, Zr, Nb, Mo, W, and Bi). A specific example thereof includes Li_{0.744}[Li_{0.145}Mn_{0.625}Co_{0.115}Ni_{0.115}]O₂, and the like.

The positive electrode preferably includes, in addition to the positive electrode active material, a solid electrolyte selected from the solid electrolyte group consisting of a sulfide solid electrolyte, an oxide solid electrolyte, and a halide solid electrolyte, and more preferably, at least a part of the surface of the positive electrode active material is coated with a sulfide solid electrolyte, an oxide solid electrolyte, or a halide solid electrolyte. As the halide solid electrolyte covering the at least a part of the surface of the positive electrode active material, Li_{6-(4-x)b}(Ti₁₋ₓAlₓ)_{b}F₆ (0<x<1, 0<b≤1.5)[LTAF electrolyte] is preferable.

Examples of the conductive material include carbon material. The electrolyte may be a solid electrolyte or a liquid electrolyte. The solid electrolyte may be an organic solid electrolyte such as a gel electrolyte, or an inorganic solid electrolyte such as an oxide solid electrolyte or a sulfide solid electrolyte. In addition, the liquid electrolyte (electrolyte) contains, for example, a support salt such as LiPF₆ and a solvent such as a carbonate-based solvent. Examples of the binder include a rubber-based binder and a fluoride-based binder.

The negative electrode active material layer contains at least a negative electrode active material. The negative electrode active material layer may further contain at least one of a conductive material, an electrolyte, and a binder. Examples of the negative electrode active material include a metal active material such as Li and Si, a carbon active material such as graphite, and an oxide active material such as Li₄Ti₅O₁₂. The shape of the negative electrode current collector is, for example, a foil shape or a mesh shape. The conductive material, the electrolyte and the binder are similar to those described above.

The electrolyte layer is disposed between the positive electrode active material layer and the negative electrode active material layer, and contains at least an electrolyte. The electrolyte may be a solid electrolyte or a liquid electrolyte. The electrolyte layer is preferably a solid electrolyte layer. The electrolyte layer may have a separator.

The solid electrolyte preferably includes at least one solid electrolyte species selected from the solid electrolyte group consisting of a sulfide solid electrolyte, an oxide solid electrolyte, and a halide solid electrolyte.

The sulfide solid electrolyte preferably contains sulfur (S) as a main component of the anionic element, and further preferably contains, for example, an Li element, an A element, and an S element. The A element is at least one selected from the group consisting of P, As, Sb, Si, Ge, Sn, B, Al, Ga, and In. The sulfide solid electrolyte may further contain at least one of O and a halogen element. Examples of the halogen element (X) include F, Cl, Br, and I. The composition of the sulfide solid electrolyte is not particularly limited, and examples thereof include xLi₂S·(100−x)P₂S₅ (70≤x≤80), and yLiI·zLiBr·(100−y−z)(xLi₂S·(1−x)P₂S₅) (0.7≤x≤0.8, 0≤y≤30, and 0≤z≤30). The sulfide solid electrolyte may have a composition represented by the following formula (1).

Li₄₋ₓGe₁₋ₓPₓS₄ (0<x<1) (1)

In the formula (1), at least a part of Ge may be substituted by at least one selected from the group consisting of Sb, Si, Sn, B, Al, Ga, In, Ti, Zr, V, and Nb. At least a part of P may be substituted by at least one selected from the group consisting of Sb, Si, Sn, B, Al, Ga, In, Ti, Zr, V, and Nb. A part of Li may be substituted by at least one selected from the group consisting of Na, K, Mg, Ca, and Zn. A part of S may be substituted with halogen. Halogen is at least one of F, Cl, Br, and I.

The oxide solid electrolyte preferably contains oxygen (O) as a main component of the anionic element, and may contain, for example, Li, a Q element (Q represents at least one of Nb, B, Al, Si, P, Ti, Zr, Mo, W, and S), and O. Examples of the oxide solid electrolyte include a garnet-type solid electrolyte, a perovskite-type solid electrolyte, a NASICON-type solid electrolyte, a Li—P—O type solid electrolyte, and a Li—B O type solid electrolyte. Examples of the garnet-type solid electrolyte include Li₇La₃Zr₂O₁₂, Li₇₋ₓLa₃(Zr₂₋ₓNbₓ)O₁₂ (0≤x≤2), and Li₅La₃Nb₂O₁₂. Examples of the perovskite-type solid electrolyte include (Li, La)TiO₃, (Li, La)NbO₃, and (Li, Sr)(Ta, Zr)O₃. Examples of the NASICON-type solid electrolyte include Li(Al, Ti)(PO₄)₃, Li(Al, Ga)(PO₄)₃. Examples of the Li—P—O solid electrolyte include Li₃PO₄, UPON (a compound in which a part of O of Li₃PO₄ is substituted by N), and examples of the Li—B—O solid electrolyte include Li₃BO₃, a compound in which a part of O of Li₃BO₃ is substituted by C.

As the halide solid electrolyte, a solid electrolyte containing Li, M, and X (M represents at least one of Ti, Al, and Y, and X represents F, Cl, or Br) is preferable. Specifically, Li_{6-3z}Y_{z}X₆ (X represents Cl or Br, and z satisfies 0<z<2), and Li_{6-(4-x)b}(Ti₁₋ₓAlₓ)_{b}F₆ (0<x<1, 0<b≤1.5) are preferable. Among Li_{6-3z}Y_{z}X₆, Li₃YX₆ (X represents Cl or Br) is more preferred in terms of excellent lithium ion conductivity, and Li₃YCl₆ is further preferred. Further, Li_{6-(4-x)b}(Ti₁₋ₓAlₓ)_{b}F₆ (0<x<1, 0<b≤1.5) is preferably included together with a solid electrolyte such as a sulfide solid electrolyte from the viewpoint of suppressing oxidative decomposition of the sulfide solid electrolyte, for example.

The positive electrode current collector collects current from the positive electrode active material layer. Examples of the positive electrode current collector include stainless steel, aluminum, nickel, iron, titanium, and carbon, and an aluminum alloy foil or an aluminum foil is preferable. The aluminum alloy foil and the aluminum foil may be manufactured using powder. The shape of the positive electrode current collector is, for example, a foil shape or a mesh shape.

The negative electrode current collector collects current from the negative electrode active material layer. Examples of the material of the negative electrode current collector include metals such as copper, SUS, and nickel. Examples of the shape of the negative electrode current collector include a foil shape and a mesh shape.

### Battery Structure

The structure of the solid battery has a laminated structure of a positive electrode, a solid electrolyte layer, and a negative electrode. The solid-state battery includes a so-called all-solid-state battery using a solid electrolyte as an electrolyte, and the solid electrolyte may include an electrolyte of less than 10 mass % based on the total amount of the electrolyte. The solid electrolyte may be a composite solid electrolyte including an inorganic solid electrolyte and a polymer electrolyte.

The positive electrode includes a positive electrode active material layer and a current collector, and the negative electrode includes a negative electrode active material layer and a current collector.

The solid electrolyte layer may have a single-layer structure or a multilayer structure of two or more layers.

The solid battery may have, for example, a cross-sectional structure shown in FIG. 4, and the solid electrolyte layer B may have a two-layer structure as shown in FIG. 4. FIG. 4 is a schematic cross-sectional view illustrating an example of a solid-state battery. The solid-state battery illustrated in FIG. 4 includes a negative electrode including a negative electrode current collector 113 and a negative electrode active material layer A, a solid electrolyte layer B, and a positive electrode including a positive electrode current collector 115 and a positive electrode active material layer C. The negative electrode active material layer A includes a negative electrode active material 101, a conductive auxiliary agent 105, and a binder 109. The positive electrode active material layer C includes a coated positive electrode active material 103, a conductive auxiliary agent 107, and a binder 111, and the coated positive electrode active material 103 is coated with a LTAF electrolyte or a LiNbO₃ electrolyte.

Further, the solid battery may be configured by sealing the laminated end face (side face) of the laminated structure of the positive electrode/solid electrolyte layer/negative electrode with resin. The current collector may have a structure in which a buffer layer, an elastic layer, or a Positive Temperature Coefficient (PTC) thermistor layer is disposed on the surface.

### Battery

The laminated battery in the present disclosure is typically a lithium ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (BEV), plug-in hybrid electric vehicle (PHEV) or battery electric vehicle (BEV). Also, the battery in the present disclosure may be used as a power source for mobile bodies other than vehicles (for example, railroads, ships, and aircraft), and may be used as a power source for electric products such as an information processing device.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

What is claimed is:

1. A method for manufacturing a laminated battery including an electrode body and a laminate film that covers the electrode body and encapsulates the electrode body inside, the laminate film including a structure in which at least a metal layer and a protective resin layer on an outer side of the metal layer are laminated, the laminate film including a fused portion in which ends overlap each other and inner surfaces are fused, the method comprising a bending step of forming one or more bent portions by bringing a bending member into contact with the fused portion and bending the fused portion in an angular or arcuate shape at an angle of 90° or less, wherein
the bending member is made of a conductive material, and
the bending step is a step of performing bending while checking conduction between the bending member and the metal layer of the laminate film.

2. The method according to claim 1, wherein the bending member is a fulcrum member to be brought into contact with a valley folding side of the bent portion of the laminate film as a fulcrum.

3. The method according to claim 1, wherein the bending step is a step of forming the bent portion by placing a bending roll as the bending member and bringing the bending roll into contact with the fused portion of the laminate film while moving the laminated battery in a direction conforming to rotation of the bending roll.

4. The method according to claim 3, wherein the bending step is a step of forming the bent portion by placing a plurality of the bending rolls in a moving direction of the laminated battery and bringing the bending rolls sequentially into contact with the fused portion of the laminate film while moving the laminated battery, and performing the bending while checking conduction between at least the bending roll finally in contact with the bent portion and the metal layer of the laminate film.

5. An apparatus for manufacturing a laminated battery including an electrode body and a laminate film that covers the electrode body and encapsulates the electrode body inside, the laminate film including a structure in which at least a metal layer and a protective resin layer on an outer side of the metal layer are laminated, the laminate film including a fused portion in which ends overlap each other and inner surfaces are fused, the apparatus comprising:
a bending member made of a conductive material and configured to form a bent portion by coming into contact with the fused portion and bending the fused portion in an angular or arcuate shape at an angle of 90° or less; and
a conduction checker connected to the bending member and the metal layer of the laminate film and configured to check conduction between the bending member and the metal layer.
